(19) United States
(12) Patent Application Publication
(10) Pub. No.: US 2022/0276687 A1
(43) Pub. Date: Sep. 1, 2022

(54) PORT ROLE ASSIGNMENTS

(71) Applicant: Hewlett-Packard Development Company, L.P., Spring, TX (US)

(72) Inventors: Binh T. Truong, Spring, TX (US); Nam H. Nguyen, Spring, TX (US); ThienDung Huynh, Spring, TX (US)

(73) Assignee: Hewlett-Packard Development Company, L.P., Spring, TX (US)

(21) Appl. No.: 17/637,630

(22) PCT Filed: Oct. 15, 2019
(86) PCT No.: PCT/US2019/056241

§ 371 Date: Feb. 23, 2022

(51) Int. Cl. G06F 1/26; G06F 1/3296; G06F 13/10

(52) U.S. Cl. CPC G06F 1/266; G06F 1/3296; G06F 13/102; G06F 2213/0042

(57) ABSTRACT

An example system may include a processor and a non-transitory machine-readable storage medium storing instructions executable by the processer to determine, by referencing a firmware configuration setting, a universal serial bus (USB) port role to be assigned to a USB port when a condition is detected by the firmware; and send, to a power delivery (PD) controller of the USB port, a command to assign the USB port role to the USB port responsive to a detection of the condition.

### BACKGROUND

Computing devices may connect with one another. For example, computing devices may connect with one another via connectors such as cables, plugs, and/or sockets. Connected computing devices may communicate and/or distribute power across connectors.

### BRIEF DESCRIPTION OF THE DRAWINGS

FIG. 1 illustrates an example of a system for port role assignments consistent with the present disclosure.

FIG. 2 illustrates an example of a host computing device for port role assignments consistent with the present disclosure.

FIG. 3 illustrates an example of a non-transitory machine-readable memory and processor for port role assignments consistent with the present disclosure.

FIG. 4 illustrates an example of a method for port role assignments consistent with the present disclosure.

### DETAILED DESCRIPTION

Computing devices may connect to other computing devices, peripherals, consumer electronic devices, etc. across a Universal Serial Bus (USB) port. A USB port may include a cable connection interface for establishing such communications. USB ports may provide a connection point between devices. The USB port may facilitate communication of both data and power. For example, the USB port may be utilized to transfer data between connected devices and be utilized to supply power to one of the connected devices while they are connected. The USB port may utilize specifications for connectors and protocols for connection.

In some examples a computing device may supply power to a connected device. In some examples, the power may be supplied to the connected device regardless of a state of the computing device. For example, the computing device may be in one of a plurality of power states defined by the Advanced Configuration and Power Interface (ACPI) specification.

An ACPI power state may include an S0 state. An S0 state may include a working state, In an S0 state the computing device and/or its operating system (O/S) may be fully usable and operational. An ACPI power state may include an S1 sleep state, an 32 sleep state, and/or an S3 sleep state. In the S1, S2, S3 sleep states the computing device may appear to be off and the power consumed in these states may be less than the S0 state and more than an S4 state. In the S3 state, the computing device may consume less power than when it is in the S2 state. In the S2 state, the computing device may consume less power than the Si state. In the Si, S2, and/or S3 state, the volatile memory may be kept refreshed to maintain a system state. Some components may remain powered in S1, S2, and S3 states so that the computing device may wake from an input to the component. An ACPI power state may include an S4 state. An S4 state may include a hibernation state where the system appears to be off and power consumption is reduced to a lowest level. In the S4 state, the computing device may save the contents of volatile memory to a hibernation file to preserve the state of the operating system, applications, and devices and the DRAM may be powered off. An ACPI power state may include an S5 state. In the S5 state, the computing device may appear off, have performed a full shutdown, and during a full shutdown and boot the user session may be torn down and restarted on the next boot.

In some examples, supplying power to a connected device over a USB port may affect the operation of other devices in proximity to the computing device and/or the connected device. For example, passing power through the port to a connected device and/or operating a connected device utilizing the supplied power may disrupt the functioning of a device in proximity to the computing device and/or the connected device.

For example, a connected device may include a USB wireless signal adapter. A USB wireless signal adapter may include a wireless signal transceiver. The USB wireless signal adapter may, when receiving power through the USB port, emit wireless signals. The emission of wireless signals may adversely affect and/or interfere with the operation of an electronic device that is in proximity to the USB wireless signal adapter.

In some settings, such as a medical care setting, the emission of interfering signals may pose risks to the function of other devices and to patients being cared for in the proximity. For example, a signal may interfere with the proper function of diagnostic and/or life support systems in a medical care setting. As such, computing devices with active USB ports may not be utilized in environments such as the medical care setting because the power supplied through the USB port of the computing device to a connected device may interfere with diagnostic and/or life support systems.

In order to have computing devices present in such environments, the USB port may be completely shut off to prevent supplying power to a connected device over a USB port. However, without power at the USB port the connection of a device to a USB port of a computing device may not be detected. As such, the connected device may not be properly initialized to the computing device. Further, a device with a rechargeable battery that is connected to the computing device via the USB port may not have its rechargeable battery charged. As such, when a user retrieves the connected device expecting its battery to be recharged by virtue of its connection to the computing device, the user may be left with a non-functional and/or uncharged device. Moreover, if the connected device is a peripheral device that relies on data and/or power connections to operate, the connected device may be inoperable when the USB port is shut off. As such, peripheral devices such as multi-function printers connected via USB may not be able to be utilized when the USB port is shut off.

In contrast, examples consistent with the present disclosure may include a configurable dynamic port role assignment system. For example, a system may include a processor and a non-transitory machine-readable storage medium to store instructions. The instructions may be executable by the processor to determine, by referencing a firmware configuration setting, a USB port role to be assigned to a USB port when a condition is detected by the firmware; and send, to a power delivery (PD) controller of the USB, a command to assign the USB port role to the USB port responsive to a detection of the condition.

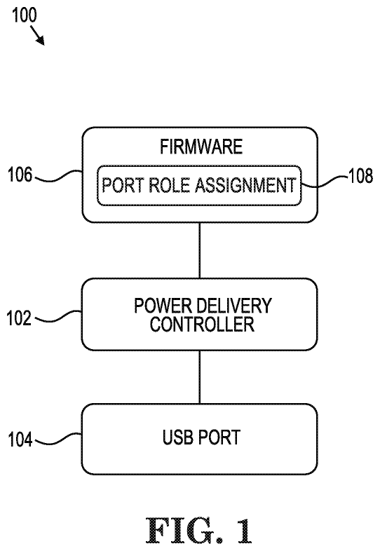

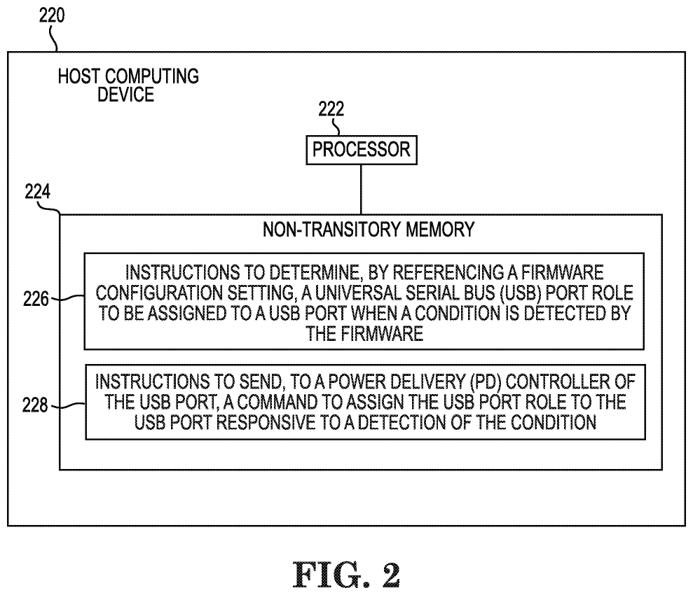

FIG. 1 illustrates an example of a system 100 for port role assignments consistent with the present disclosure. The described components and/or operations of the system 100 may include and/or be interchanged with the described components and/or operations described in relation to FIG. 2-FIG. 4.

The system 100 may include a USB port 104. The USB port 104 may include a USB port of a computing device, That is, the USB port 104 may be part of, integrated within, and/or communicatively coupled to a computing device. The computing device may include a desktop computer, a laptop computer, a tablet computer, a server, a smartphone, a wearable computer, a smart accessory, an Internet-of-things (IoT) device, a building management device, a consumer electronic device, a monitor, etc.

The USB port 104 may be a USB-C type port. For example, the USB port 104 may include a socket for receiving a twenty-four-pin double-sided USB-C plug. The USB port 104 may facilitate the transfer of power and/or data between the computing device and a connected device.

The USB port 104 may be operated as a downstream facing port (DFP), an upstream facing port (UFP), and/or a dual-role-data (DRD) port. When operating as a DFP, the USB port 104 may operate as a source. For example, a USB port 104 may include a host computing device port, a port on a hub, a docking station port, etc. that may be operated as a DFP, For example, the USB port 104 may source V_{BUS} power (e,g., as a power path between the host computing device to a connected device) and may also source VCONN power (e.g., to power electronically marked cables), VBUS may include a pin and/or shielded wire at the USB port 104 that may be utilized to supply a power supply to a connected peripheral. For example, VBUS may include a pin of a USB port 104 that may be utilized to supply a 5-volt power supply to a peripheral. Sourcing VBUS may include providing the power across the VBUS pin from the device with the USB port 104. VCONN may include a pin and/or shielded wire at the USB port 104 that may be utilized to power passively electronically marked or active cables. Sourcing the VCONN may include providing the power across the VCONN pin from the device with the USB port 104. Additionally, the USB port 104 may take on the host DFP data role.

When operating as a UFP, the USB port 104 may operate as a sink. For example, the USB port 104 may sink VBUS. Sinking VBUS may include drawing the power from the VBUS pin to power the device with the USB port 104. A USB port 104 operating as a UFP may include a port on a device or hub that is connected to a host computing device (e.g., a computing device supplying power and/or assigning port roles among two connected devices) or to a DFP of a hub, such as a tablet connected to the host computing device to charge the tablet's battery. When operating as a UFP, the USB port 104 may take on the device UFP data role.

When operating as a DIAD, the USB port 104 may operate as either a DFP or a UFP. For example, the USB port 104 may operate as a sink or a source. Additionally, the USB port 104 may alternate operation between the DFP and UFP port role operations. For example, the data role that the USB port 104 is initially assigned may be based on a power role of the device with the USB port 104 when another device is attached. For example, whether the USB port is initially assigned a DFP data role or UFP data role may be determined based on whether the device with the USB port 104 is operating as a sink or a source upon attachment to another device. For example, a USB port 104 of a device that initially is operating as a source may take on the data role of a DFP and a USB port 104 of a device that is initially operating as a sink may take on the data role of the UFP. However, these roles may be changed during operation.

The system 100 may include a PD controller 102. The PD controller 102 may be associated with and/or control the USB port 104. A PD controller 102 may be part of and/or be communicatively coupled to a computing device. The computing device may be a device that the USB port 104 is resident within and/or communicatively coupled to. The PD controller 102 may include hardware and/or instructions executable by the hardware to assign a role to its associated USB port 104.

The PD controller 102 may operate by facilitating a communication between two connected devices. For example, communication between two devices connected via the USB port 104 may be facilitated by the PD controller 102 in order to negotiate a power and/or data communication operating roles. The PD controller 102 may cause power to flow both ways across the USB port 104 with no set direction based on a circuit connection.

In some examples, the PD controller 102 may be utilized to change the operating role of the USB port 104. For example, the PD controller 102 of a first device may negotiate with a PD controller of a second device connected to the first device via the USB port 104. The PD controller 102 may negotiate to designate a port role to be assigned to the USB port 104 and/or the USB port of the connected second device. For example, the respective PD controllers of connected devices may negotiate to determine whether their associated USB port is to be operate as UFP or DFP. Negotiating between the PD controllers may include digital communication between transmitter and receiver ends of a PD connection to determine the flow of data, the flow of power, debugging protocols, etc, The negotiations may be accomplished by a series of digital queries, answers, and/or advertisements regarding the capabilities and/or demands of each device. The USB port 104 may operate according to the role assigned to it by the PD controller 102.

As described above, the USB port 104 may be part of and/or communicatively coupled to a computing device. The computing device may include a collection of hardware and instructions executable by the hardware to perform various functions.

The instructions of the computing device may include firmware 106. Firmware 106 may include instructions, embedded in a computing device, that provide low-level control for the computing device's specific hardware and/or may provide a standardized operating environment for the computing devices more complex hardware. Firmware 106 may include a basic input output system (BIOS) and/or a Unified Extensible Firmware Interface (UEFI). The firmware 106 may include instructions stored on the motherboard of the computing device. The firmware 106 may be the instructions executable to perform Power-On Self-Test (POST). The firmware may be executable to perform functions such as booting and peripheral control, The firmware 106 may be utilized to identify and configure hardware of the computing device such as the hard drive, floppy drive, optical drive, CPU, memory, etc. It is further contemplated that the functionalities described with reference to the firmware 106 may also be carried out by an embedded controller of the computing device.

The firmware 106 may detect that a second device has been connected to the USB port 104. For example, the firmware 106 may communicate with the PD controller 102 and/or the USB port 104. For example, firmware 106 may place a call during POST to execute a USB initialization (INIT) call in order to detect a device connected to the USB port 104. The USB I NIT call may include a callback function which is called during initialization to determine the various components and/or their order of installation needed for initialization of the connected device. The results of this execution may be utilized by the firmware 106 to determine whether drivers are needed to place the connected device in a functional state. The drivers may then be retrieved and/or installed.

Further, the firmware 106 may detect the type of the connected device from the USB INIT call. For example, based on the execution of the USB INIT call a device class, a device id, a chipset, etc. may be determined for the connected device connected to the USB port 104. In some examples, the firmware 106 may detect that the device connected to the USB port 104 is a thumb drive, a wireless signal adapter, a multifunction printer, a smartphone, a portable hard drive, a tablet computer, a docking station, etc.

The firmware 106 may be configurable. For example, the firmware 106 may be configurable or may be altered through an interface. The interface may include a firmware setup utility. The interface may include different settings that may alter the functions of the firmware 106. For example, the interface may include a plurality of firmware configuration settings that may be modified through the interface. Modifications to the different settings may adjust the functions of the firmware 106.

For example, a user may issue a command (e.g., press an F10 button on a keyboard connected to the computing device) to open a firmware setup utility. Within the firmware setup utility, a user may modify firmware configuration settings.

Modifying the firmware configuration settings may include specifying and/or modifying specifications of various types of devices that may be connected to the USB port 104. The specified device types may correspond to and/or be identifiable by the device type information that the firmware 106 receives upon execution of the USB INIT call during post.

A firmware configuration setting may include a port role assignment 108. A port role assignment 108 may include a description, for each of a plurality of types of devices that may be connected to the USB port 104, of a port role assignment 108 to be assigned to the USB port 104 when a condition is detected. As such, modifying the firmware configuration settings may include modifying, for each of a plurality of types of devices that may be connected to the USB port 104, a port role assignment 108 to be assigned to the USB port 104 when a condition is detected.

The port role specified in the port role assignment 108 may be a type-specific port role to be assigned to the USB port 104. That is, the port role to be assigned to the USB port 104 may be specific to a type of device that is connected to the USB port 104. For example, a first port role may be assigned if a first type of device is connected and a second port role may be assigned if a second type of device is connected. The type-specific port role assignments 108 may be stored in a memory location at and/or accessible to the computing device with the firmware 106, the PD controller 102, and/or the USB port 104. For example, the type-specific port role assignments 108 may be stored on a non-volatile read only memory (ROM) chip or flash memory chip on a motherboard of the computing device with the USB port 104. As such, the firmware 106 may be utilized to access and/or modify the type-specific port role assignments 108 at the memory location.

A port role may specify how the USB port 104 should be operated when the device type is connected to the USB port 104. For example, a port role may specify that the USB port 104 should be operated as a UFP port role, a DFP port role, a DRD port role, a disabled port role, etc. The port role may specify how power is to be distributed across the USB port 104. For example, the port role may specify whether the computing device with the USB port 104 will be a sink or source, an amount of power that will be communicated across the USB port 104, etc. The port role may specify how data is communicated across the USB port 104. For example, the port role may specify whether data can be accessed on the computing device with the USB port 104. The port role may specify whether data can be communicated from the computing device with the USB port 104L The port role may specify whether data can be communicated to the computing device with the USB port 104, etc. Further, the port role may specify the type of data that can be accessed on and/or communicated to or from the computing device via the USB port 104.

The port role assignments 108 may be condition-based assignments of port roles to the USB port 104. A condition may include an occurrence detectable by a computing device and/or the firmware 106. For example, a condition may include a detectable power state and/or operational state of a computing device, a connected device, a port etc. A condition may include a state of a physical environment of the USB port 104 and/or its connected device detectable by the computing device, a connected device, a port, etc

A particular condition may be specified by the port role assignment 108 that, when detected, would trigger the assignment of the port role to the type of device. For example, a first type of device may be specified by the port role assignment 108. For that first type of device, a UFP port role to be assigned upon the detection of a first condition may be specified by the port role assignment 108. Conversely, the port role assignment 108 may specify, for the first type of device, a DFP port role is to be assigned upon detection of a second condition. In this manner, a same device type may be dynamically assigned and/or reassigned differing port roles based on the occurrence of various conditions. As such, the port role assigned to the USB port 104 may not be static but may be able to be modified to respond to the occurrence of various conditions specified by the port role assignments 108 that may customized or altered, etc.

The condition may include a state of the computing device with the USB port 104, a state of a device connected to a USB port 104, and/or operational states of connected devices detectable by the firmware 106. The firmware 106 may detect the condition upstream of the USB port 104, downstream of the USB port 104, and/or at the USB port 104.

Examples of conditions may include a power state of the computing device with the USB port 104. As described above, a power state may include a state at a computing device corresponding to a particular amount of power consumption, software states, and/or hardware states, For example, the condition may include an ACPI power state of the computing device with the USB port 104. The power state at a computing device may reflect the software and/or hardware activity of the device. When a computing device is in a power state corresponding to a sleeping or low power state it may be because the computing device is in an environment (e.g., a patient care situation) with a device that is sensitive to the operation of other electronic devices and the computing device has been placed into the power state to avoid such interference.

In some examples, the condition may include an operational state of the device connected to the USB port 104. An operational state may include how a device connected to the USB port 104 is functioning. For example, an operational state may include an activated mode or capability of the connected device. For example, the condition may include whether a docking station has a computing device docked into it. The operation state may be indicative of a demand for power or data transmission at the connected device. In the docking station example, a docking station with nothing docked may not be utilizing power and/or data transmissions.

In some examples, the condition may include a presence of other types of devices within a proximity to the USB port 104 that may be interfered with and/or adversely affected by the operation of a connected device across the USB port 104. For example, the condition may include the presence of a heart monitoring device within a physical proximity to the USB port 104.

In some examples, the condition may include the detection of data indicating the presence of a type of device in proximity to the USB port 104 that may be interfered with and/or adversely affected by the operation of a connected device across the USB port 104. For example, the condition may include the presence of a data tag in a patient's electronic medical records, retrieved at the computing device with the USB 104, indicating that the patient has a device and/or will be receiving a diagnostic screening from a device that may be interfered with and/or adversely affected by the operation of a connected device across the USB port 104. For example, a patient's medical record may include data indicating that the patient is wearing a monitor to measure the electrical activity of a heartbeat. Such monitors may have their operation interfered with by the generation of electromagnetic interference generated by a device connected to the USB port 104.

As such, the port role assignments 108 may specify port role triggering conditions that may be stored in a memory location at and/or accessible to the computing device with the firmware 106, the PD controller 102, and/or the USB port 104. For example, the port role triggering conditions assigned to various device types may be stored on a non-volatile read only memory (ROM) chip or flash memory chip on a motherboard of the computing device with the USB port 104. As such, the firmware 106 may be utilized to access and/or modify the port role triggering conditions assigned to various device types at the memory location.

The firmware 106 may communicate with the PD controller 102 and/or the USB port 104 regarding the port role assignments 108 specified in the firmware configuration settings. For example, the firmware 106 may place a virtual wire call to the PD controller 102 to communicate the above-described type-specific condition-based port roles assignable to the USB port 104 associated with the PD controller 102. The virtual wire call may include a digital call across a virtual wire logically binding the firmware 106 and the PD controller 102 together allowing for traffic to pass between the interfaces without switching or routing intermediaries. In some examples, the firmware 106 and the PD controller 102 may both have access to a common memory location or a registry. In such examples, communication between the firmware 106 and the PD controller 102 may be accomplished by writing to and/or reading from the commonly accessible memory location and/or registry.

For example, the firmware 106 may have access to a registry that is a portion of and/or accessible to the PD controller 102. A registry, as referred to herein, may refer to a registry setting of a PD controller 102. The registry may include a database or memory location within the PD controller 102 where configuration settings for the PD controller 102 may be stored and/or referenced by the PD controller 120 for implementation. That is, a registry may refer to a registry setting inside a PD controller 102 and not an O/S windows registry.

As such, the firmware 106 may communicate with the PD controller 102 by writing the type-specific condition-based port roles assignable to the USB port 104 to the registry. The PD controller 102 may receive the type-specific condition-based port roles assignable to the USB port 104 by reading from the registry where the port role assignment 108 is saved. In some examples, the firmware 106 may send other types of direct communication to the PD controller 102.

As described above, the particular port roles assignable to the USB port 104 may have multiple variables (e.g., the particular device type connected to the USB port 104, the particular condition to trigger the assignment, etc.) which facilitate the dynamic and flexible assignment of port roles that may be adaptable to a variety of situations and/or user preferences. For example, the firmware 106 may communicate a description of a port role assignment 108 specifying a port role to be assigned to a USB port 104 when a device of a particular type is connected to the USB port 104 and when a particular condition is detected. As described above, for each device type a distinct port role may be assignable to the USB port 104 under a particular condition. Further, for a particular device type a distinct port role may be assignable to the USB port 104 for each of a plurality of distinct conditions. In this manner, a port role of a USB port 104 may change with changing conditions detected by the firmware 106,

The firmware 106 may monitor for and detect the occurrence of the various conditions. For example, the firmware 106 may detect the ACPI power state of the computing device with the USB port 104. The firmware 106 may communicate a detection of the occurrence of the condition to the PD controller 102. For example, the firmware 106 may communicate, to the PD controller 102, a detected ACPI power state of the computing device with the USB port 104, The firmware 106 may send a virtual wire communication to the PD controller 102 to communicate the occurrence of the condition. The firmware 106 may write a message communicating the detection of the occurrence of the condition to the common registry or memory location that is a portion of and/or accessible to the PD controller 102.

The combination of the condition-based type-specific port role assignment specified in the port role assignment 108 and the detection of the corresponding condition communicated from the firmware 106 to the PD controller 102 may serve as a command from the firmware 106 to the PD controller 102. That is, the communication of the condition-based type-specific port role assignment specified in the port role assignment 108 and the detection of the corresponding condition may serve as a command to assign the specified USB port role to the USB port 104.

The PD controller 102 may assign the USB port role specified in the port role assignment 108 to the USB port 104 responsive to the communication from the firmware 106 of the condition-based type-specific port role assignment for the type of device connected to the USB port 104 and responsive to the detection of the corresponding condition. For example, the PD controller 102 may receive the communication that a particular condition has been detected. Then the PD controller 102 may reference its registry to determine what port role is should assign to the USB port 104 based on the type-specific port role assignment corresponding to the type of device that is connected to the USB port role 104 and corresponding to the detected particular condition for that type of device, The PD controller 102 may assign the determined port role to the USB port 104 and cause the USB port 104 to be operated according to the assigned port role. In some examples, the USB port 104 may be operated according to the assigned port role until a second condition is detected and/or until a second device type is detected connected to the USB port 104.

FIG. 2 illustrates an example of a host computing device 220 for port role assignments consistent with the present disclosure, The described components and/or operations described with respect to the host computing device 220 may include and/or be interchanged with the described components and/or operations described in relation to FIG. 1 and FIG. 3-FIG. 4.

The host computing device 220 may include a computing device with USB ports integrated and/or communicatively coupled thereto, The computing device may be a host device. A host device may be a device that is physically hosting and/or controlling the operation of the USB ports. That is, the term host may not refer to a computing or network hierarchy or a predetermined sink or source designation, but rather the role of the computing device as the manager of the USB ports being described. In some examples, the computing device may include a desktop computer, a laptop computer, a tablet computer, a server, a smartphone, a wearable computer, a smart accessory, an Internet-of-things (IoT) device, a building management device, a consumer electronic device, a monitor, etc.

The host computing device 220 may include a processor 222 and/or a non-transitory memory 224, The non-transitory memory 224 may include instructions (e.g., 226, 228, etc,) that, when executed by the processor 222, cause the host computing device 220 to perform various operations described herein. While the host computing device 220 is illustrated as a single component, it is contemplated that the host computing device 220 may be distributed among and/or inclusive of a plurality of such components.

The host computing device 220 may include instructions 226 executable by the processor 222 to determine a USB port role to be assigned to a USB port, Specifically, the USB port role may be a USB port role that is to be assigned to a USB port when a device of a particular type is connected to the USB port. Further, the USB port role may be a USB port role that is to be assigned to the USB port when a particular condition is detected by the firmware of the host computing device 220.

The USB port role may be determined by referencing a firmware configuration setting in the host computing device 220. The firmware configuration setting may be configurable. For example, the firmware configuration setting may be configurable or may be altered through an interface. The interface may include a firmware setup utility. The interface may include different settings that may alter the functions of the firmware. For example, the interface may include a plurality of firmware configuration settings that may be modified through the interface. Modifications to the different settings may adjust the functions of the firmware. In some examples, the firmware configuration settings may be configured by a user and/or an administrator of the host computing device 220 via the firmware setup utility interface.

The firmware configuration settings may be configured to specify type-specific condition-based port roles for a plurality of device types across a variety of conditions. In this manner, the port role assignments at the host computing device 220 may be flexible and may be configured to automatically adapt to disparate situations detected at the host computing device 220.

The host computing device 220 may include instructions 228 executable by the processor 222 to communicate from the firmware of the host computing device 220 to a PD controller for the USB port of the host computing device 220. For example, the communication may include a command to assign the USB port role to the USB port responsive to a detection of the condition.

The command may be a communication of the firmware configuration settings. For example, the firmware may communicate a plurality of type-specific condition-based port roles assignable to the USB port. That is, the firmware may write into a registry of the PD controller a plurality of different device types and a plurality of different port roles for each of those device types where each of the plurality of different port roles corresponds to a particular detected condition.

The command may further include a notification that the particular condition has been detected by the firmware of the host computing device 220. For example, the firmware of the host computing device 220 may write to a registry of the PD controller that the particular condition has been detected.

The combination of the instructions regarding which port role to assign for a particular connected device type when a particular condition is detected may suffice as a command to assign the USB port role to the USB port. The command may cause the PD controller of the host computing device 220 to operate the USB port of the host computing device 220 according to the assigned USB port role. In some examples, the USB port of the host computing device 220 may have already had an initial port role assignment (e.g., determined by PD controller negotiation, initial power source or sink determinations, etc.). In such examples, the PD controller may switch the port role assigned to the USB port to the newly determined USB port role to be assigned to the USB port.

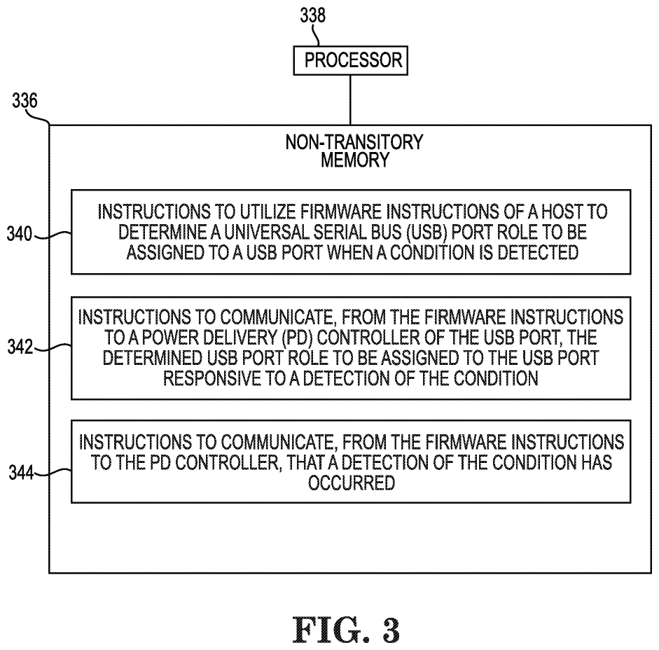

FIG. 3 illustrates an example of a non-transitory machine-readable memory 336 and processor 338 for port role assignments consistent with the present disclosure. A memory resource, such as the non-transitory machine-readable memory 336, may be utilized to store instructions (e.g., 340, 342, 344, etc.). The instructions may be executed by the processor 338 to perform the operations as described herein. The operations are not limited to a particular example described herein and may include and/or be interchanged with the described components and/or operations described in relation to FIG. 1-FIG. 2 and FIG. 4.

The non-transitory memory 336 may store instructions 340 executable by the processor 338 to utilize firmware instructions of a host computing device to determine a USB port role to be assigned to a USB port. The firmware instructions may reference configurable firmware configuration settings to determine the USB port role to be assigned to a USB port.

For example, firmware configuration settings may include a plurality of potential USB port role assignments. Each of the plurality of potential USB port role assignments may correspond to a respective device type of a device connected to the host computing device through the USB port. The port role may effectively designate the power, data, and/or functionality provided to and/or received from a device connected to the USB port. Further, each of the plurality of potential USB port role assignments may correspond to an occurrence of a condition that may trigger assignment of the USB port role.

When a device is connected to the host computing device, the firmware instructions of the host computing device may detect the connection. The firmware instructions may detect a device type of the connected device. For example, the firmware instructions may utilize a USB INIT call to identify that the connected device is a docking station for a laptop computer. As such, the firmware instructions may reference the firmware configuration settings to determine the USB port role assignable to the docking station under various conditions.

The non-transitory memory 336 may store instructions 342 executable by the processor 338 to communicate, from the firmware instructions to the PD controller of the USB port, the determined USB port role to be assigned to the USB port responsive to the detection of the condition. The communication may be accomplished utilizing a virtual wire communication between the firmware instructions and the PD controller. In some examples, the firmware instructions may write the determined USB port role to be assigned to the USB port responsive to the detection of the condition to a registry of the PD controller. The PD controller may reference the registry to determine the USB port role to be assigned to the USB port responsive to the detection of the condition.

For example, the firmware instructions may write the USB port role assignable to the USB port for a docking station device type connected to the USB port. The firmware instructions may specify a condition to trigger the assignment. For example, the firmware instructions may specify a particular docking state (e.g., laptop docked to docking station, laptop not docked to docking station, etc.) for the docking station that will trigger the assignment of the USB port role to the USB port.

The non-transitory memory 336 may store instructions 344 executable by the processor 338 to communicate, from the firmware instructions to the PD controller, that a detection of the condition has occurred. For example, the firmware instructions may detect the occurrence of a condition at the host computing device and may report the detection to the PD controller. The firmware instructions may communicate the detection via a virtual wire call. The firmware instructions may communicate the detection via writing the detection into a registry of the PD controller.

The USB port of the host computing device may have an initially assigned port role. The initially assigned port role may be a port role previously assigned to the USB port responsive to the occurrence of a previous condition. As such, the host computing device may include instructions to utilize the PD controller to switch from the initially assigned port role of the USB port to the determined USB port role assignable to the USB port. The determined USB port role may be different from the initially assigned port role of the USB port.

Additionally, the determined USB port role may be assigned to the USB port regardless of a USB port role requested by a device coupled to the USB port. For example, as described above, a connected device may effectively request that the USB port be assigned a particular port role by acting as a power source, acting as a power sink, and/or engaging in negotiations between its PD controller and the PD controller of the USB port at the host computing device upon initially being connected to the USB port. That is, the determined USB port role assigned to the USB port may be a different port role port role than was initially indicated by the power source status, power sink status, and/or PD controller negotiations of the connected device, etc.

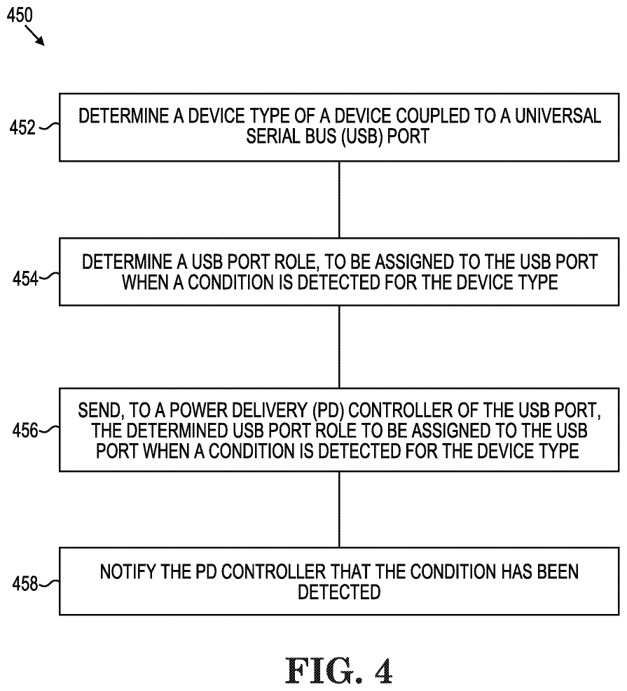

FIG. 4 illustrates an example of a method 450 for port role assignments consistent with the present disclosure. The described components and/or operations of method 450 may include and/or be interchanged with the described components and/or operations described in relation to FIG. 1-FIG. 3.

At 452, the method 450 may include determining a device type of a device coupled to a USB port. The device type may be determined by firmware of a host computing device. The firmware may detect that the device has been connected to the USB port. For example, the firmware may detect a data transfer and/or a voltage change across the pins of the USB port. The firmware may generate an INIT call to initiate a driver discover and installation process. The firmware may determine, based on communication with a PD controller of the USB port and/or a PD controller of a connected device, the device type of the connected device.

At 454, the method 450 may include determining a USB port role to be assigned to the USB port when a condition is detected for a device type. The USB port role to be assigned to the USB port and/or the condition to trigger the assignment may be determined based on user configured firmware configuration settings.

At 456, the method 450 may include sending, to a PD controller of the USB port, the determined USB port role to be assigned to the USB port when a condition is detected for the device type. For example, a virtual wire may be sent from firmware operating on the host computing system to the PD controller of the USB port of the host computing system that writes a description of the USB port role to be assigned to the USB port when a condition is detected for the device type to a memory location accessible to the PD controller.

For example, instructions may be sent to the PD controller specifying that if the connected device is a smartphone device type and the condition of the host computing system entering an S5 ACPI power state is detected, then a DRP port role should be assigned by the PD controller to the USB port. That is, if the connected device is a smartphone then the USB port will be operated by the PD controller as a DRP port that will either take power or provide power depending on whether the phone battery can be charged when the host computing device is in the S5 power state.

Instructions may be sent to the PD controller specifying that if the connected device is a multi-function printer (MFP) device type and the condition of the host computing system entering an S5 ACPI power state is detected, then a DFP port role should be assigned by the PD controller to the USB port. That is, if the connected device is an MFP then the USB port will be operated by the PD controller as a DFP port that will continue to consistently provide power to the MFP when the host computing system is in an S5 power state.

Instructions may be sent to the PD controller specifying that if the connected device is a thumb drive device type and the condition of the host computing device entering an s5 ACPI power state is detected, then a UFP port role should be assigned by the PD controller to the USB port. That is, if the connected device is a thumb drive then the USB port will be operated by the PD controller as a UFP port to cut the thumb drive off from a power supply while the host computing device is in the 35 power state.

Instructions may be sent to the PD controller specifying that if the connected device is a wireless signal adapter device type and the condition of the host computing device entering an S5 ACPI power state is detected, then a disabled port role should be assigned by the PD controller to the USB port. That is, if the connected device is a wireless signal adapter then the USB port will be disabled by the PD controller to prevent the port from providing or receiving power from the wireless signal adapter when the host computing system is in an S5 power state.

Other device type-based and condition-specific port role assignments are contemplated. For example, a user may specify port role assignment for each of a plurality of distinct device type and condition combinations. In this manner, a user may customize USB port operation to tailor the operation of USB ports to an environment, an operating protocol, and/or a set of user preferences. The operation of USB ports may not be forced into the static and/or generically applied on or off port roles. Instead, the USB ports of a computing device may be operated with more specificity and granularity to adapt the computing device and its USB ports to a variety of environments.

At 458, the method 450 may include notifying the PD controller that the condition has been detected. That is, the PD controller may have been provided with the port role assignment applicable when a condition has been detected, but the PD controller may not include the instructions to detect the condition. Instead, the detection may be handled by the firmware of the host computing device and/or by another mechanism reporting the conditions to the firmware of the host computing device. The firmware may communicate to the PD controller that the condition has been detected.

The PD controller may, responsive to the notification of the detection, reference a memory location to determine what port role should be assigned to the device type with the detected condition. The PD controller may assign the corresponding port role to the USB port and the USB port may be operated according to the port role. The operation under the assigned port role may continue until another condition is detected and/or until the detected condition is no longer detected.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. Further, as used herein, “a plurality of” an element and/or feature can refer to more than one of such elements and/or features.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

What is claimed:

1. A system, comprising:
a processor; and
a non-transitory machine-readable storage medium to store instructions executable by the processor to:
determine, by referencing a firmware configuration setting, a universal serial bus (USB) port role to be assigned to a USB port when a condition is detected by the firmware; and
send, to a power delivery (PD) controller of the USB port, a command to assign the USB port role to the USB port responsive to a detection of the condition.

2. The system of claim 1, wherein the condition includes an advanced configuration and power interface (ACPI) sleep state of the system.

3. The system of claim 1, including instructions to determine a device type of a device coupled to the USB port.

4. The system of claim 3, including instructions to determine the USB port role to be assigned to the USB port based on the device type of the device coupled to the USB port.

5. The system of claim 1, wherein the USB port role is selected from the group comprising a downstream facing port role, an upstream facing port role, a dual role port role, and a disabled port role.

6. The system of claim 1, wherein the command to assign the USB port role to the USB port responsive to the detection of the condition and a notification of the detection of the condition is communicated from the firmware instructions to the PD controller.

7. The system of claim 1, wherein the command to assign the USB port role to the USB port responsive to the detection of the condition and a notification of the detection of the condition is communicated from an embedded controller to the PD controller.

8. A non-transitory machine-readable storage medium comprising instructions executable by a processor to:
utilize firmware instructions of a host to determine a universal serial bus (USB) port role to be assigned to a USB port when a condition is detected;
communicate, from the firmware instructions to a power delivery (PD) controller of the USB port, the determined USB port role to be assigned to the USB port responsive to a detection of the condition; and
communicate, from the firmware instructions to the PD controller, that a detection of the condition has occurred.

9. The non-transitory machine-readable storage medium of claim 8, including instructions to communicate, from the firmware instructions to the PD controller, of the determined USB port role to be assigned to the USB port responsive to the detection of the condition by writing the determined USB port role assignable to the USB port responsive to the detection of the condition to a registry of the PD controller.

10. The non-transitory machine-readable storage medium of claim 8, wherein the determined USB port role to be assigned to the USB port is different than an initially assigned port role of the USB port.

11. The non-transitory machine-readable storage medium of claim 10, including instructions to utilize the PD controller to switch from the initially assigned port role of the USB port to the determined USB port role assignable to the USB port regardless of a USB port role requested by a device coupled to the USB port.

12. The non-transitory machine-readable storage medium of claim 8, wherein the condition includes the docking status of a docking station coupled to the USB port.

13. A method comprising:
determining a device type of a device coupled to a universal serial bus (USB) port;
determining a USB port role to be assigned to the USB port when a condition is detected for the device type;
sending, to a power delivery (PD) controller of the USB port, the determined USB port role to be assigned to the USB port when the condition is detected for the device type; and
notifying the PD controller hat the condition has been detected.

14. The method of claim 12, including altering, based on user input, a basic input/output system (BIOS) configuration setting specifying the USB port role to be assigned to the USB port when the condition is detected for the device type.

15. The method of claim 12, wherein sending the PD controller the determined USB port role to be assigned to the USB port when the condition is detected for the device type includes sending, to the PD controller of the USB port, instructions to toggle a USB port role assignment to an upstream facing port (UFP) port role assignment for a thumb drive device type with power off responsive to a detection that a host has entered an s5 sleep state.
